(19) United States
(12) Patent Application Publication
(10) Pub. No.: US 2004/0194362 A1
(43) Pub. Date: Oct. 7, 2004

(54) Label structure for pistol type pneumatic tool

(76) Inventor: Lung-Hui Chen, Jubei City (TW)

Correspondence Address: BIRCH STEWART KOLASCH & BIRCH, PO BOX 747, FALLS CHURCH, VA, 22040-0747, US

(21) Appl. No.: 10/406,283

(22) Filed: Apr. 4, 2003

(51) Int. Cl. G09F 3/02

(52) U.S. Cl. 40/628

(57) ABSTRACT

The invention provides a label structure for pistol type pneumatic tool, which is provided on the end surface of driving portion corresponding to the other end of quick coupler of pistol type pneumatic tool. In addition, expressed by text, numbers, or illustrations, the label structure can submit important information clearly and apparently. Moreover, through the advantages that the label structure can be firmly provided on the smooth end surface of driving portion and that the end surface is at the same side as the backend of grip portion, the label structure can be apparent to a user. Therefore, when the user is gripping the pistol type pneumatic tool and doing a mechanical operation, the user is able to read information showed on the label structure easily and clearly at the same time.

### FIELD OF THE INVENTION

The invention relates to a label structure for pistol type pneumatic tool and, more particularly, to a label structure that is provided on the end surface of a driving portion corresponding to the other end of quick coupler of a pistol type pneumatic tool so that a user can read information provided on the end surface simultaneously when operating the tool.

### BACKGROUND OF THE INVENTION

The structure of a pistol type pneumatic tool, such as pneumatic socket wrench, pistol type pneumatic screwdriver, pneumatic staple gun, pneumatic grinder, pneumatic jaw crusher, pneumatic drill, pistol type pneumatic spade, or pneumatic chamfering machine, primarily includes a grip portion for a user to manipulate the tool by hand, and a driving portion located on top of the grip portion perpendicularly. Pneumatic tools are broadly used in many fields because they are compact in style, easy to be operated, and simple to be maintained; therefore, they are handy for simple, small mechanical work.

In addition, pistol type pneumatic tools have many different types, and one type of tool or a tool produced by a specific manufacturer can be different from another type of tool in style and operating procedures. However, some conventional manufacturers only focus on designing of various models for pistol type pneumatic tools; they do not pay much attention to labeling information such as trademark, product specification, or operation method on the surface of pistol type pneumatic tool. Therefore, tool users often have to look for operation instructions on their own. On the other hand, other manufacturers may provide different kinds of label on driving portion or grip portion of pistol type pneumatic tool. The contents of some labels are usually expressed in text along with some close-ups so that the provided information can be introduced to its readers rapidly. Besides, the contents of other labels may intend to demonstrate images for products, whereas the rest of the labels may intend to prevent counterfeit products as well as to promote products.

The foregoing pistol type pneumatic tool is to provide label on driving portion or grip portion of a tool so as to specify designed model or provide information for the tool. However, the external shape of driving portion or grip portion often cannot be so simple and smooth because the internal mechanical design of a tool can be very special or it may employ ergonomic design for human comfort. Consequently, it will not be easy to firmly fix a planar label or a solid label on the driving portion or grip portion. Besides that, if a label is fixed on the grip portion, the user's hand may block the label when gripping the tool; therefore, it is inconvenient for the user to follow the instructions on the label. Moreover, a label fixed on the grip portion is prone to be scratched, smeared, and torn more easily.

### SUMMARY OF THE INVENTION

Therefore, in order to solve the above problems, the invention is to firmly label important information on the smooth surface of a pistol type pneumatic tool, and through an advantage that the end surface is at the same side as the backend of grip portion, the label can be apparent to a user so that the user can clearly read the information on the label when operating the pistol type pneumatic tool.

To achieve the above-mentioned object, the label structure for pistol type pneumatic tool of the invention is designed to be a label structure that can be provided at an appropriate position on the surface of pistol type pneumatic tool. The pistol type pneumatic tool includes a grip portion and a driving portion that is located on top of the grip portion. A quick coupler is provided at one end of driving portion, and the label structure is provided on the end surface of driving portion that is corresponding to the other end of quick coupler of pistol type pneumatic tool. Besides, the end surface is at the same side as the backend of grip portion. Therefore, when the user is gripping the grip portion and doing a mechanical operation at one end of the driving portion, the user is able to read information showed on the label structure easily and clearly.

### BRIEF DESCRIPTION OF THE DRAWINGS

FIG. 1 is a schematic diagram showing first embodiment of the invention.

FIG. 2 is a schematic diagram showing second embodiment of the invention.

FIG. 3 is a schematic diagram showing third embodiment of the invention.

### DETAILED DESCRIPTION OF THE PREFERRED EMBODIMENTS

The structure and technical contents of the invention will be described below with reference to the drawings.

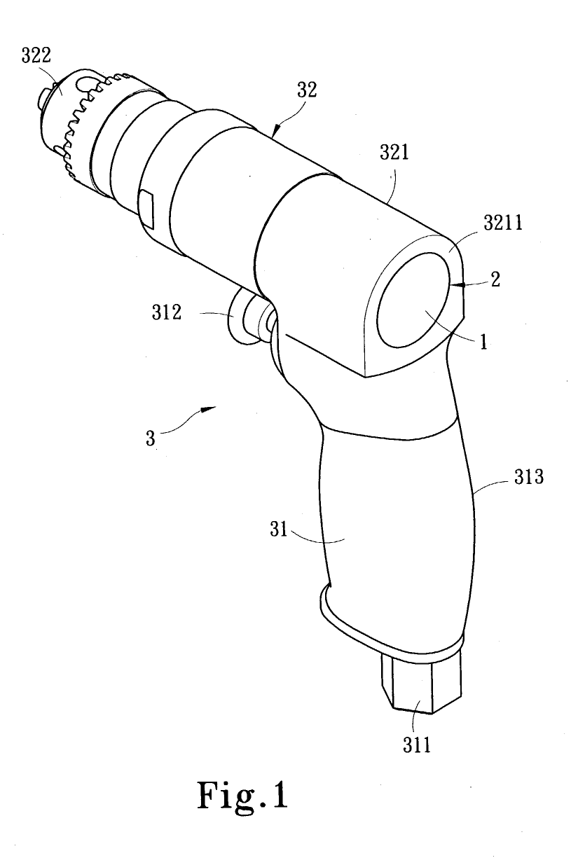

FIG. 1 is a schematic diagram showing first embodiment of the invention. Referring to FIG. 1, the label structure for pistol type pneumatic tool of the invention is a label structure 1 that is provided at an appropriate position on the surface of a conventional pistol type pneumatic tool 3. The pistol type pneumatic tool 3 primarily includes a grip portion 31 and a driving portion 32. An air-circulating channel 311 and a trigger 312 are provided on the grip portion 31, and one end of driving portion 32 is conjoined to the grip portion 31. Besides, a transmission device 321 is provided inside the driving portion 32, whereas a quick coupler 322 that is connected to certain mechanical equipment (not shown) is provided on the other end of the driving portion 32.

The label structure 1 of the invention can be any kind of planar label or solid label made of transparent waterproof material and can be directly attached to the end surface 3211 of driving portion 32 corresponding to the other end of quick coupler 322 of pistol type pneumatic tool 3. Besides, the end surface 3211 is at the same side as the backend 313 of grip portion 31. Thus, because of that the label structure 1 can be firmly fixed on the smooth end surface 3211 and that the end surface 3211 is at the same side as the backend 313 of grip portion 31, the label structure 1 can be more apparent to a user. Therefore, when the user is gripping the grip portion 31 and operating the mechanical equipment (not shown) that is connected into the quick coupler 322 on the driving portion 32, the user is able to read information showed on the label structure 1 easily and clearly at the same time.

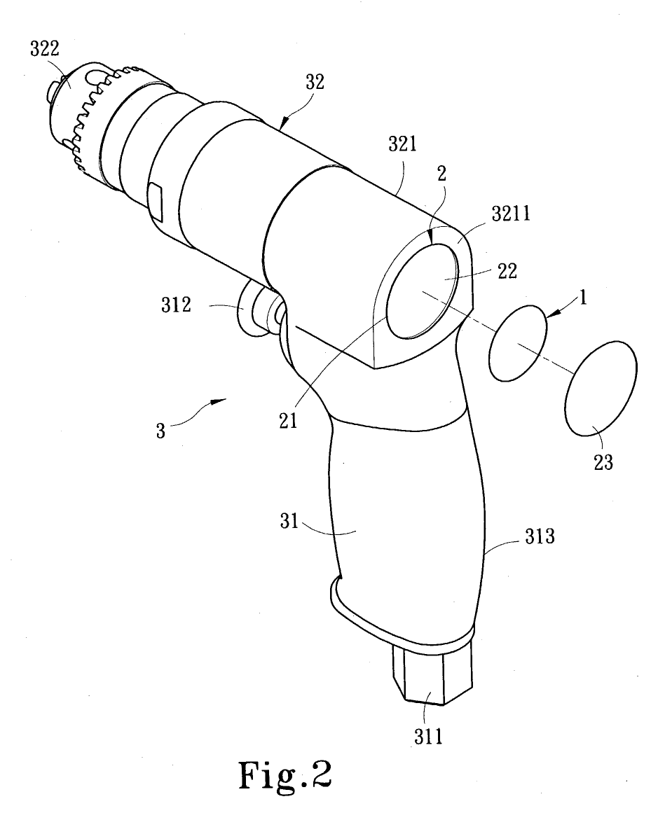

Next, FIG. 2 is a schematic diagram showing second embodiment of the invention. Referring to FIG. 2, a assembling concavity 2 is provided and inwardly curved on the end surface 3211 of driving portion 32 corresponding to the other end of quick coupler 322 of pistol type pneumatic tool 3. The assembling concavity 2 can be in any appropriate shape, and it also includes a positioning portion 21 and an accommodating portion 22 thereon.

The label structure 1 of the invention can be located inside the accommodating portion 22 of the assembling concavity 2 and can also be fixed on the assembling concavity 2 by means of positioning portion 21 without being removed or falling off. Additionally, a transparent shielding cover 23 can be provided on the assembling concavity 2 to protect the label structure 1 inside the accommodating portion 22 from damage so that important information can be kept intact.

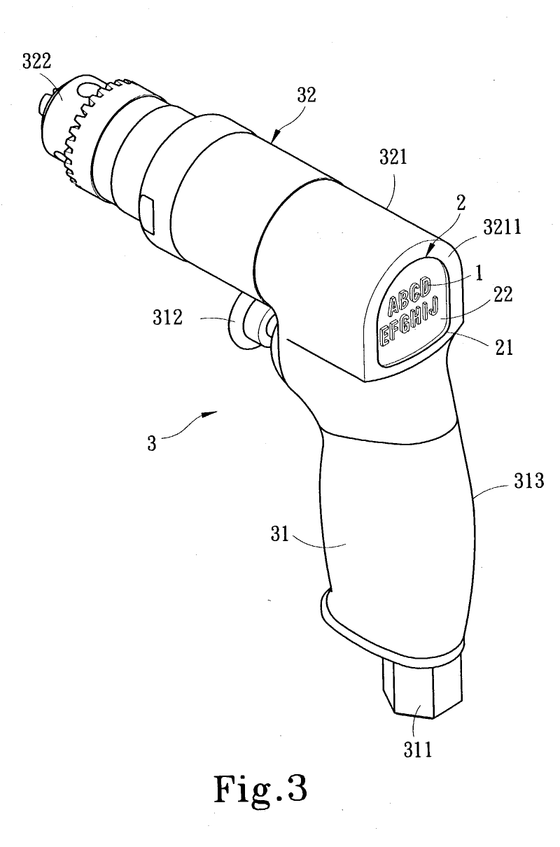

Further, FIG. 3 is a schematic diagram showing third embodiment of the invention. Referring to FIG. 3, the label structure 1 of the invention can be printed on the accommodating portion 22 of the assembling concavity 2 by die-casting so that the label structure 1 can become part of the surface design of pistol type pneumatic tool. Unless the label structure 1 is being destroyed intentionally, it will stay on the surface of the tool forever.

Moreover, the label structure 1 of the invention can be expressed in numbers, in different languages according to the countries to be exported, or in illustrations when key operation method or application instruction other than text is required in description.

Furthermore, aside from the advantage that it will not affect the overall external design of the pistol type pneumatic tool 3, the label structure 1 provided on the end surface 3211 of driving portion 32 corresponding to the other end of quick coupler 322 of pistol type pneumatic tool 3 also has the following advantages:

1. When the user is gripping the grip portion 31 and operating mechanical equipment (not shown) connected into the quick coupler 322 on the driving portion 32, the user is able to read information showed on the label structure 1 easily and clearly at the same time. Therefore, the label structure 1 is easy to be identified and capable of showing operating instructions as well as increasing product promotion.

2. The label structure 1 allows each pistol type pneumatic tool 3 to own its unique label structure, which means the tool will not be easy to be copied; therefore, counterfeit products can be prevented, and the owner of brand name tool can be ensured to have product authenticity and retroactivity.

3. The end surface 3211 of driving portion 32 that is corresponding to the other end of quick coupler 322 of pistol type pneumatic tool 3 can be either a plane surface or an arc surface to facilitate the label structure 1 making thereon.

Finally, to sum up, the label structure 1 of the invention can offer one of or some of the following messages:

1. To describe type, classification, usage, operation method, functionality, placement, or maintenance for the pistol type pneumatic tool 3.

2. To name the product.

3. To remind users about security rules.

4. To notify safety distance or the range of dangerous operation when a product is in use.

5. To illustrate seal of approval after product inspection.

6. To illustrate company's trademark, patent, or identification number.

What is claimed is:

1. A label structure for pistol type pneumatic tool, which is provided at an appropriate position on the surface of pistol type pneumatic tool, including a grip portion and a driving portion located on top of the grip portion; a quick coupler is provided at one end of driving portion, and the label structure is located on the end surface of driving portion that is corresponding to the other end of quick coupler of pistol type pneumatic tool; besides, the end surface of driving portion is at the same side as the backend of grip portion.

2. The label structure for pistol type pneumatic tool as claimed in claim 1, wherein the end surface of driving portion corresponding to the other end of quick coupler of pistol type pneumatic tool can be either a plane surface or an arc surface.

3. The label structure for pistol type pneumatic tool as claimed in claim 1, wherein the label structure can be any kind of planar label or solid label directly fixed onto the end surface of driving portion that is corresponding to the other end of quick coupler.

4. The label structure for pistol type pneumatic tool as claimed in claim 1, wherein the label structure can be made of waterproof material.

5. The label structure for pistol type pneumatic tool as claimed in claim 1, wherein the assembling concavity can be provided by inwardly curved on the end surface of driving portion corresponding to the other end of quick coupler.

6. The label structure for pistol type pneumatic tool as claimed in claim 5, wherein the assembling concavity includes a positioning portion and an accommodating portion.

7. The label structure for pistol type pneumatic tool as claimed in claim 5, wherein a shielding cover can be provided on the assembling concavity.

8. The label structure for pistol type pneumatic tool as claimed in claim 7, wherein the shielding cover can be transparent.

9. The label structure for pistol type pneumatic tool as claimed in claim 1, wherein the label structure can be located between the assembling concavity and the shielding cover.

10. The label structure for pistol type pneumatic tool as claimed in claim 1, wherein the label structure can be directly printed on the accommodating portion of assembling concavity by means of die-casting.

11. The label structure for pistol type pneumatic tool as claimed in claim 1, wherein the label structure can be expressed in any kind of the following forms: text, numbers, or illustrations.
